(19) United States
(12) Patent Application Publication
(10) Pub. No.: US 2007/0064685 A1
(43) Pub. Date: Mar. 22, 2007

(54) Methods and apparatus for providing toll-free telephone services

(76) Inventors: Susanne Marie Crockett, Buffalo Grove, IL (US); Robert Bryan Lasken, Schaumburg, IL (US); Rick Yuh-Herng Lin, Elk Grove, CA (US)

Correspondence Address: HANLEY, FLIGHT & ZIMMERMAN, LLC, 150 S. WACKER DRIVE, SUITE 2100, CHICAGO, IL, 60606, US

(21) Appl. No.: 11/227,396

(22) Filed: Sep. 15, 2005

(51) Int. Cl. H04L 12/66

(52) U.S. Cl. 370/356

(57) ABSTRACT

Methods and apparatus for providing toll-free telephone services are disclosed. A disclosed system comprises a telephone network to route a telephone call placed to a toll-free telephone number to one of a Voice over Internet Protocol (VoIP) endpoint, a Plain Old Telephone Service (POTS) endpoint or a dedicated trunk endpoint based on a state of at least one variable.

### FIELD OF THE DISCLOSURE

This disclosure relates generally to telephone services and systems and, more particularly, to methods and apparatus for providing toll-free telephone services.

### BACKGROUND

Currently, a telephone call (i.e., calls) placed to a toll-free telephone number (e.g., 8YY-NXX-XXXX) is routed by a first telephone network (e.g., a local telephone network, a wireless network, etc.) originating the call to a second telephone network (e.g., a long-distance telephone network) operated by the service provider of the toll-free number (i.e., the toll-free service). The first telephone network uses a database of associated toll-free numbers and carrier identification codes (CICs) to determine the route (e.g., the feature group trunk) to the second telephone network. The first and the second telephone networks may be operated by the same or different service operators.

The second telephone network then determines a destination for the call, e.g., a Plain Old Telephone Service (POTS) number or a dedicated trunk (standard, voice-grade data-access line (DAL), primary rate interface (PRI), etc.). Typically, the destination at least depends upon a time-of-the-day and day-of-the-week configuration. For example, calls placed Monday through Friday during 8 am-5 pm are routed to a customer service center. Outside of those hours, calls are routed to an after-hours service center (e.g., a pager service, answering service, etc.). The second telephone network may factor in standard holidays, or the call origination location or number when determining the destination. For example, a toll-free call placed from Mexico could be routed to a call center with representatives capable of speaking Spanish. Instead of a single destination, the destination may represent a group of phone numbers (i.e., route the toll-free call to the first available phone number in a list of numbers), a trunk group (i.e., use an available time slot on a dedicated facility connecting the second telephone network with a toll-free customer site), etc.

### BRIEF DESCRIPTION OF THE DRAWINGS

FIG. 1 is a schematic illustration of an example system constructed in accordance with the teachings of the invention and capable of providing toll-free services.

FIG. 2 is an example configuration record for a toll-free telephone number.

FIG. 3 is a schematic illustration of an example manner of implementing the example call router of FIG. 1.

FIG. 4 is a flowchart representative of example machine readable instructions which may be executed to determine a destination for a toll-free call.

FIGS. 5A and 5B are example web based interfaces for customizing the configuration record for a toll-free telephone number.

FIG. 6 is a schematic illustration of an example manner of implementing the example long-distance network of FIG. 1.

FIG. 7 is a schematic illustration of an example computer system capable of executing the machine readable instructions represented by FIG. 4, the example LD network of FIG. 1, the example call router of FIGS. 1 and 2, and/or to implement the systems and/or methods described herein.

### DETAILED DESCRIPTION

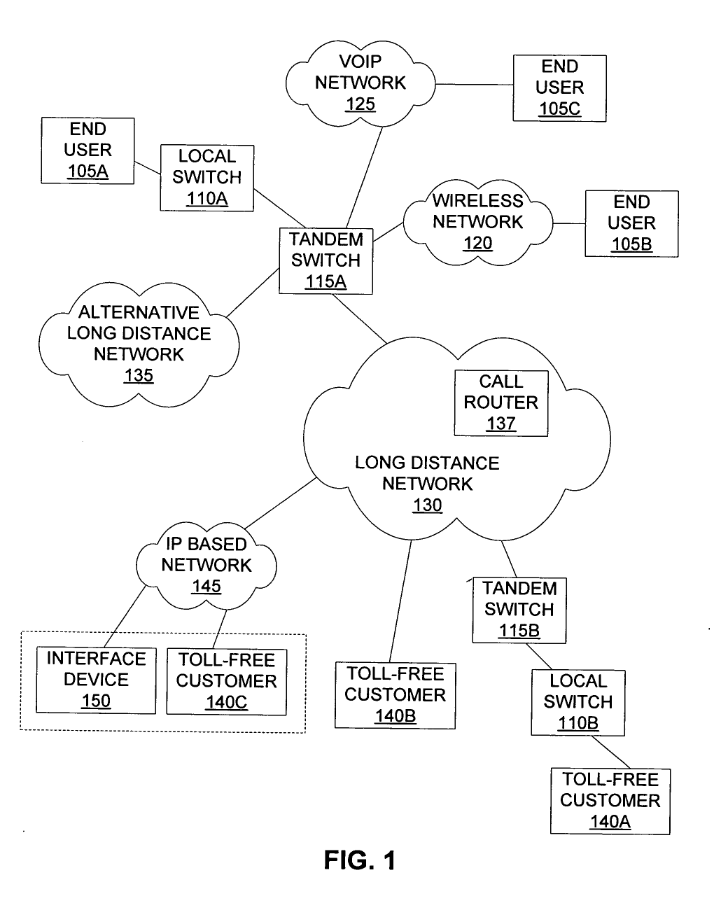

FIG. 1 illustrates an example communication system constructed in accordance with the teachings of the invention that provides toll-free telephone services. In the illustrated example of FIG. 1, an end user 105A connected to a well-known local (i.e., CLASS 5) switch 110A initiates a toll-free call to a toll-free number. The local switch 110A routes the toll-free call to a well-known tandem (i.e., CLASS 4) switch 115A. Using a database associating toll-free telephone numbers with respective Carrier Identification Codes (CICs), the tandem switch 115A determines the service provider associated with the toll-free number and information necessary to route the toll-free call to the service provider (e.g., a feature group trunk). In the example of FIG. 1, the toll-free call is routed to an example circuit-based long-distance (LD) network 130 constructed in accordance with the teachings of the invention (e.g., the WilTel^{SM} network operated by SBC®). In the example system of FIG. 1, if the service provider had been different, the call would have been routed to an alternative LD network 135 (e.g., a network operated by a company other than SBC).

As illustrated in FIG. 1, end users may also initiate toll-free calls using other access technologies. For example, end users 105B and 105C may initiate toll-free calls via a wireless network 120 and a Voice over Internet Protocol (VoIP) network 125, respectively. Toll-free calls initiated by end users 105B and 105C are routed by the tandem switch 115A as discussed above. For instance, the toll-free calls may be routed to the LD network 130 or the alternative LD network 135.

In the illustrated example of FIG. 1, the local switches 110A and 110B, the wireless network 120, and the VoIP network 125 connect to the example LD network 130 via the tandem switch 115. It will be apparent to persons of ordinary skill in the art that the local switches 110A and 110B, the wireless network 120, and the VoIP network 125 may alternatively connect directly to the LD network 130. For example, local switches (e.g., local switch 110A or 110B) operated by SBC preferably communicate directly with the example LD network 130 (e.g., the WilTel^{SM} network operated by SBC®), but may under certain circumstances communicate via a tandem switch (e.g., tandem switch 115A or 115B).

To determine a destination for the toll-free call and route the call to the destination, the example LD network 130 of FIG. 1 includes a call router 137. In the illustrated example of FIG. 1, the destination may be, for instance, a Plain Old Telephone Service (POTS) number (e.g., toll-free customer 140A) via a tandem switch 115B and local switch 110B; a dedicated trunk (standard, voice-grade data-access line (DAL), primary rate interface (PRI)) (e.g., toll-free customer 140B) connected directly to the LD network 130; a VoIP endpoint via an Internet Protocol (IP) based network 145 (e.g., toll-free customer 140C), etc.

A VoIP endpoint may be one of any variety of VoIP device or server. For example, a VoIP endpoint may be a VoIP server located, for example, in a call-center or office that handles toll-free telephone calls for one or more of a customer service, a technical support, a billing, a sales, etc. department, and that routes an incoming toll-free telephone call to one or more of a plurality VoIP phones communicatively coupled to the VoIP server. Alternatively, a VoIP endpoint may be a VoIP phone, VoIP enabled computer, etc. In a preferred example, a VoIP endpoint supports the Session Initiated Protocol (SIP) specified in Internet Engineering Task Force (IETF) Request for Comment (RFC) 2543.

In the example of FIG. 1, the call router 137 determines the destination for the toll-free call based on a configuration record associated with the toll-free number. As discussed above, the configuration record specifies a destination for a toll-free number based upon a set of time-of-the-day, day-of-the-week, day-of-the-year, etc. criterion (i.e., variables). In the illustrated example, VoIP endpoint destinations are specified in the configuration record using well-known universal resource locators (URL). Alternatively, the destinations may be specified using a numeric identifier (e.g., an IP address), some other identifier that is translated to a URL or IP address, etc.

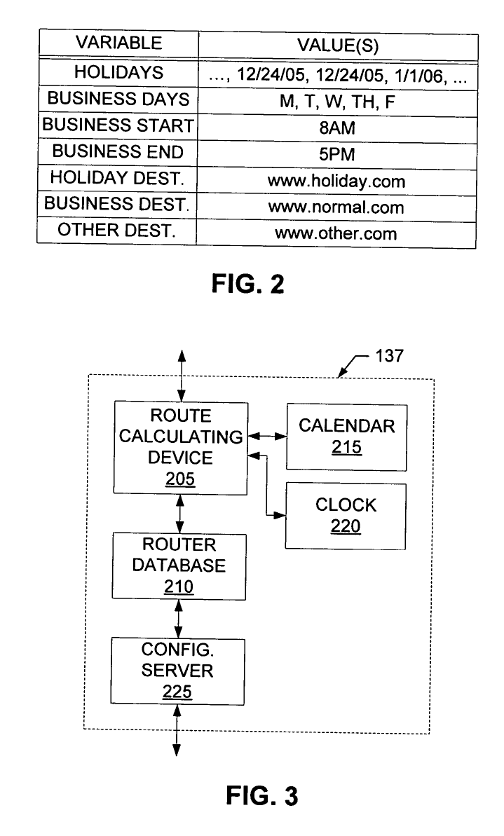

FIG. 2 illustrates an example configuration record for an example toll-free number containing variables that define which calendar days (i.e., day-of-the-year) are holidays, which day-of-the-week are business days, normal business operating hours, and a plurality of destinations. In the example of FIG. 2, a different VoIP endpoint is specified for holidays, normal business days and times, and other days and times. It will be readily appreciated by persons of ordinary skill in the art that the example configuration record could contain other variables useful for routing a toll-free call. For example, a weekend call destination variable, a variable related to the geographic location of a toll-free call origination, etc. In the illustrated example of FIG. 1, the variables contained in the configuration record are customizable by the customer associated with the toll-free number. For example, the customer can define the day-of-the-year (i.e., holiday) variable.

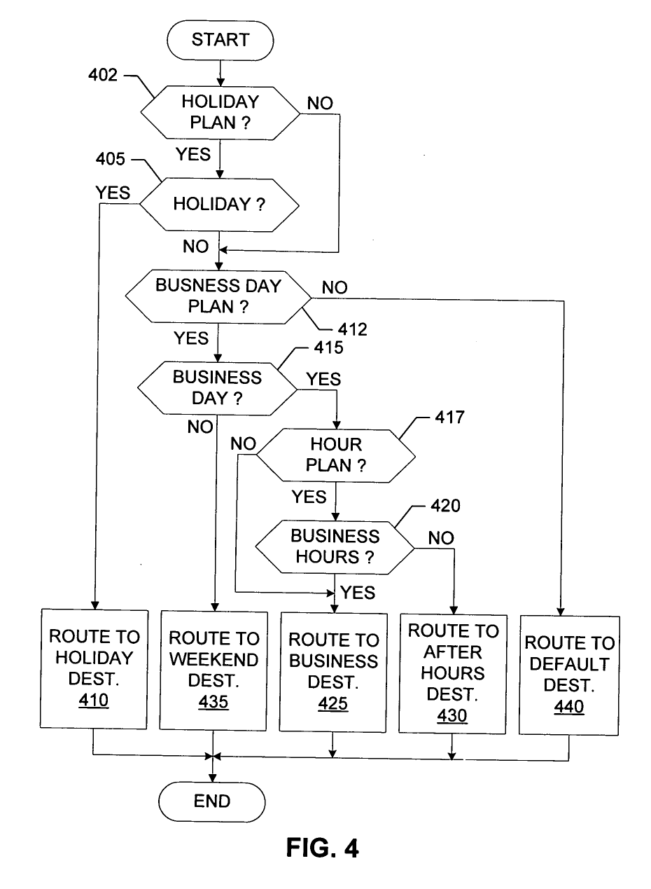

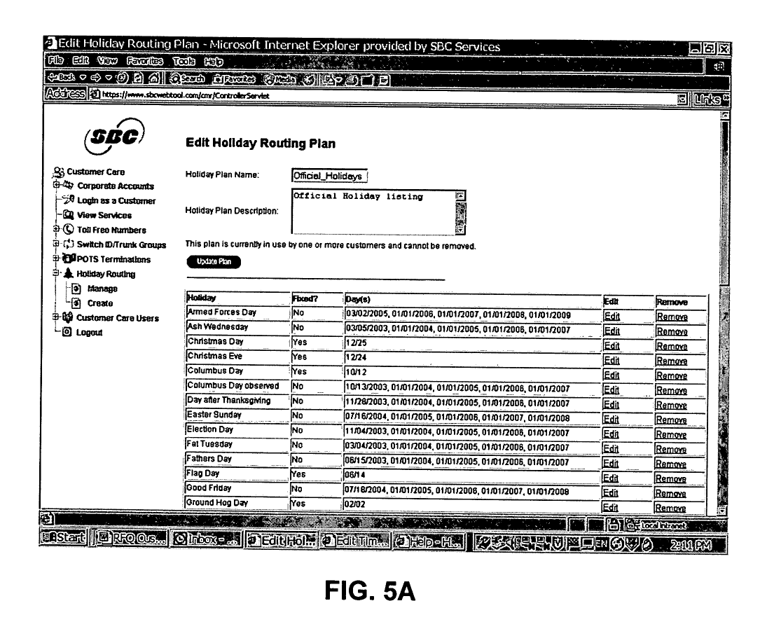

FIG. 3 is a schematic illustration of an example manner of implementing the example call router 137 of FIG. 1. To determine destinations for a telephone call (toll-free or non toll-free), the call router 137 includes a route calculating device 205, a router database 210, a calendar 215, and a clock 220. When the call router 137 receives a new toll-free telephone call, the route calculating device 205 uses the configuration record stored in the database 210 that is associated with the toll-free, the current day-of-the-year from the calendar 215, and the current time-of-the-day from the clock 220 to determine a destination for the toll-free call by, for example, executing the example machine readable instructions illustrated in and discussed below in connection with FIG. 4.

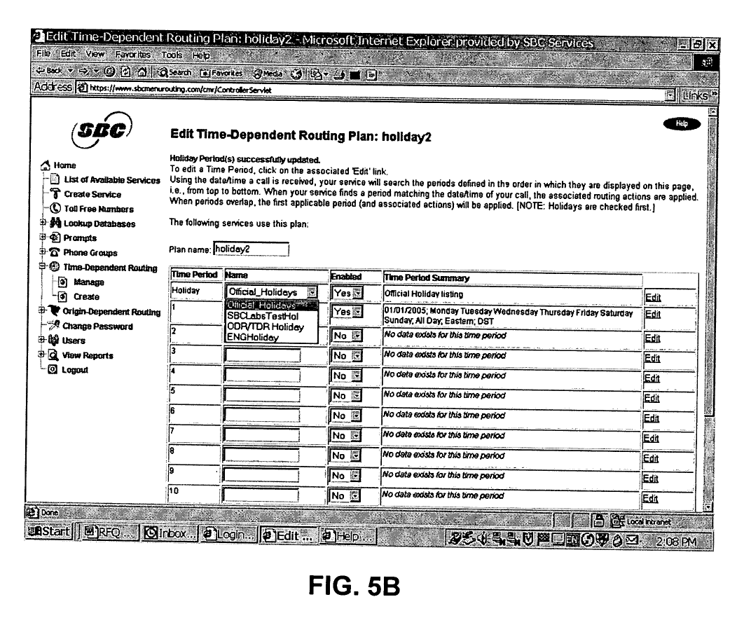

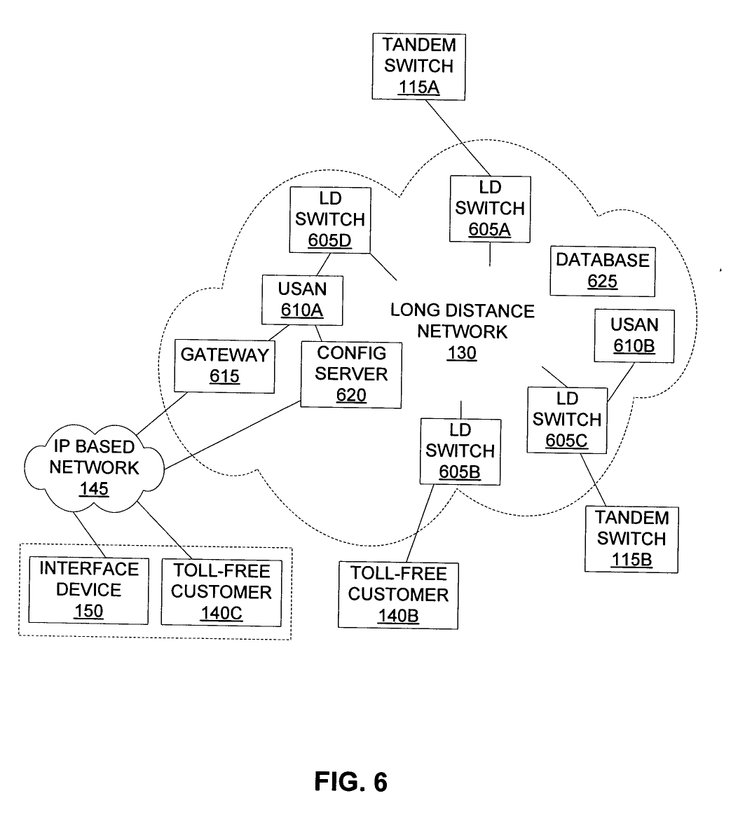

To allow the customer of a toll-free number to customize configuration records for the toll-free number as described below in connection with FIGS. 5A, 5B and 6, the call router 137 includes a configuration server 225. For example, the configuration server 225 could interact with the customer via the interface device 150 and the IP based network 145 of FIG. 1.

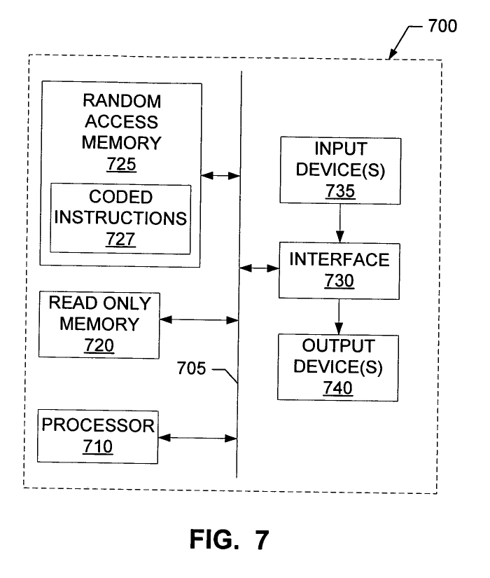

FIG. 4 illustrates a flowchart representative of example machine readable instructions that may be executed by a processor (e.g., the processor 710 of FIG. 7) to implement the example call router 137, the example LD network and/or to determine a destination for a call placed to a toll-free number. The machine readable instructions of FIG. 4, the call router 137 and/or the LD network 137 may be executed by a processor, a controller and/or any other suitable processing device. For example, the machine readable instructions of FIG. 4, the call router 137 and/or the LD network 137 may be embodied in coded instructions stored on a tangible medium such as a flash memory, or random access memory (RAM) associated with the processor 710 shown in the example processor platform 700 and discussed below in conjunction with FIG. 7. Alternatively, some or all of the example machine readable instructions of FIG. 4, the call router 137 and/or the LD network 137 may be implemented using an application specific integrated circuit (ASIC), a programmable logic device (PLD), a field programmable logic device (FPLD), discrete logic, hardware, etc. Also, some or all of the machine readable instructions of FIG. 4, the call router 137 and/or the LD network 137 may be implemented manually or as combinations of any of the foregoing techniques. Further, although the example machine readable instructions of FIG. 4 are described with reference to the flowcharts of FIG. 4, persons of ordinary skill in the art will readily appreciate that many other methods of implementing the call router 137 and/or the LD network 137 may be employed. For example, the order of execution of the blocks may be changed, and/or some of the blocks described may be changed, eliminated, sub-divided, or combined.

Further, while the example of FIG. 4 is illustrated using a flowchart, it should be understood that other methods for determining a destination could be implemented. For example, using a table look-up, using fewer or additional decision criterion (e.g., including location of the originating caller, choosing one of a plurality of destinations (e.g., a trunk group destination)), etc.

For brevity, the example machine readable instructions of FIG. 4 are described with regards to the example call router 137 of FIG. 2. However, it will be apparent to persons of ordinary skill in the art that they may be executed by the LD network 130 or a processing agent associated with the LD network 130. The example machine readable instructions of FIG. 4 begin when the call router 137 receives a new call to a toll-free number and, thus, needs to determine a destination for the new toll-free call. The route calculating device 205 determines if the database 210 (i.e., configuration record) includes a holiday configuration (i.e., day-of-the-year variable) for the toll-free number (block 402). If a holiday plan is present (block 402), the route calculating device 205 compares the current day-of-the-year to a list of holidays contained in the configuration record to determine if the current day-of-the-year is a holiday (e.g., Christmas, Labor Day, etc.) (block 405). If the current day-of-the-year is a holiday (block 405), the route calculating device 205 routes the call to the holiday destination for the toll-free number specified in the database 210 (block 410) and ends the example machine readable instructions of FIG. 4.

If the current day-of-the-year is not a holiday (block 405), the route calculating device 205 determines if the database 210 (i.e., configuration record) includes a day-of-the-week variable (i.e., business day configuration) for the toll-free number (block 412). If a day-of-the-week variable is present (block 412), the route calculating device 205 determines if the current day-of-the-week is a business day (e.g., Monday, Tuesday, . . . , Friday) (block 415).

If the current day-of-the-week is a business day (block 415), the route calculating device 205 determines if a time-of-the-day plan for the toll-free number is present in the database 210 (block 417). If a time-of-the-day configuration is present (block 417), the route calculating device 205 determines if the call was placed during normal business hours (e.g., 8 A.M. to 5 P.M.) (block 420). If the call was placed on a business day and during normal business hours (block 420), the route calculating device 205 routes the call to a normal business destination for the toll-free number (block 425) and ends the example machine readable instructions of FIG. 4. If the call was not placed during normal business hours (block 420), the route calculating device 205 routes the call to an after-hours destination for the toll-free number (block 430) and ends the example machine readable instructions of FIG. 4.

Returning to block 417, if no time-of-the-day configuration is present, the route calculating device 205 routes the call to a normal business destination for the toll-free number (block 425) and ends the example machine readable instructions of FIG. 4.

Returning to block 415, if the current day-of-the-week is not a business day, the route calculating device 205 routes the call to a weekend destination for the toll-free number (block 435) and ends the example machine executable instructions of FIG. 4.

Returning to block 412, if a day-of-the-week configuration is not present, the route calculating device 205 routes the call to a default destination of the toll-free number (block 440) and ends the example machine executable instructions of FIG. 4.

Returning to FIG. 1, the example LD network 130 allows the customer associated with the toll-free number to specify (i.e., customize) days-of-the-year that are holidays (i.e., define day-of-the-year variable(s)). For example, a customer may specify that the business days between Christmas Eve and New Years Day are holidays, while another customer may only specify Christmas Eve, Christmas and New Years Day as holidays. The example LD network 130 also allows the customer to customize time-of-the-day, day-of-the-week, call origination location, etc. variables (i.e., destinations for toll-free calls).

To allow the customer to customize the routing of toll-free calls, the example of FIG. 1 includes an interface device 150 associated with, for example, the toll-free customer 140C. In the illustrated example, the interface device 150 is connected to the LD network 130 via a well-known Internet based connection via the IP based network 145. It will be readily apparent that the interface device 150 can be implemented using any one of a variety of well known devices. For example, a Personal Computer (PC), a Personal Digital Assistant (PDA), a cell phone, etc. capable to connect to the IP based network 145 and display a web based user interface may implement the interface device 150. It will be apparent to persons of ordinary skill in the art that interface devices may be associated with each of the other toll-free customers (e.g., toll-free customers 140A and 140B) served by the example LD network 130.

The LD network 130 of the illustrated example of FIG. 1 provides a web based user interface (e.g., using the well-known Hyper Text Markup Language (HTML), eXtensible Markup Language (XML), etc.) to the interface device 150 via the IP based network 145. The web based user interface presented to the customer by the LD network 130 contains, among other things, an option to customize the routing of toll-free calls.

An example web based user interface for customizing a holiday routing plan (i.e., variable(s)) is illustrated in FIG. 5A. The web based user interface of the illustrated example contains a button, drop-down selection, or other element on the web based display entitled “Manage” Holiday Routing In response to selection of the button, selection, or element using standard web based user interface usage techniques, the LD network 130 presents via the interface 150 one or more additional web based user interfaces that allow the customer to select or specify days-of-the-year that are holidays (e.g., by selecting days-of-the-year from a presented list, by typing in specific dates, etc.) and to save and/or name the set of specified holidays (i.e., a holiday plan). Using similar techniques, the LD network 130 also provides web based user interfaces that allow the customer to customize and save time-of-the-day, day-of-the-week, call origination location, etc. plans.

FIG. 5B illustrates an example web based user interface presented by the LD network 130 via the interface 150 to allow the customer to create a customized comprehensive toll-free routing scheme by selecting and enabling one or more saved or standard variables (i.e., plans). For example, a customer may select a routing plan comprising of their customized holiday plan, a standard day-of-the-week plan, and a customized time-of-the-day plan. In the illustrated example of FIG. 5B, the web based user interface contains a plurality of drop-down lists from which the customer can select one of a plurality of standard or customized plans (e.g., standard day-of-the-week plan, customized holiday plan, standard holiday plan, etc.). Associated with each of the plurality of drop-down lists, the example web based user interface contains a drop-down list to enable or disable the associated standard or customized plan. Using the plurality of drop-down lists, the customer can create a customized comprehensive routing plan for toll-free calls placed to a toll-free number. The example web based user interface further provides button and/or other elements on the interface to save and name the customized routing plan thus created.

The customized comprehensive routing plan may be expanded to include a plurality of destinations associated with a single toll-free number. For example, as discussed below in connection with FIG. 6, a single toll-free number may be used by a caller to reach, for example, a customer service department, a billing department, technical service, etc. all associated with the single toll-free number. In particular, the LD network 130 provides an interactive voice response (IVR) system that prompts the caller to indicate a selection (e.g., by pressing a key on a telephone keypad, speaking a response, etc.) and then routes the toll-free call to the selected destination. The LD network 130 of FIG. 1 provides web based interfaces to create customized comprehensive routing plans for each of the destinations associated with a toll-free number. For example, during non-business hours and/or on non-business work days, calls to a billing department associated with a toll-free number could be routed to a voice mail service while calls to technical support would be routed to a staffed technical support center.

It will be readily apparent to persons of ordinary skill in the art that a customer could create a customized routing plan using other well-known interface techniques. For example, using an IVR system, contacting a customer service representative associated with the LD network 130, etc. In particular, the customer service representative could collect from the customer the information necessary to create the customized routing plan and then configure the routing plan for the customer (e.g., using a web based interface similar to that described above). Alternatively, the interface device 150 could be implemented using a telephone device (e.g., a wireless telephone, a land line telephone, a VoIP telephone, etc.) connected to the LD network 130 using a telephone connection (e.g., wireless, land line, or VoIP). For instance, computer generated or recorded messages provided by the LD network 130 could be played to prompt the customer to enter necessary information, the customer could enter information by pressing or selecting keys on a telephone keypad (provided by the interface device 150), and the IVR system at the LD network 130 could receive the information by decoding the Dual Tone Multi-Frequency (DTMF) signals initiated by each key press or selection.

FIG. 6 is a schematic illustration of an example manner of implementing the example LD network 130 of FIG. 1. In the illustrated example of FIG. 6, the routing of telephone calls (toll-free and non toll-free) within the LD network 130 is completed by a interconnected plurality of LD switches, e.g., 605A, 605B, 605C and 605D. The plurality of LD switches 605A-D are connected in any of a variety of topologies, e.g., ring, star, mesh, etc., as determined by the service provider operating the LD network 130.

To determine routing within the LD network 130, the example LD network 130 of FIG. 6 includes two geographically separated United States Advanced Network (USAN) servers 610A and 610B. The USAN servers 610A and 610B maintain a shared database 625 of routing information. The database 625 contains information about the location of called telephone numbers (e.g., a destination LD switch, a destination tandem switch and a destination local switch). The database 625 also contains the information necessary to route toll-free calls (e.g., URLs, IP addresses, etc.). For example, the database 625 contains the configuration records described above and customized by the customer.

A call routed to the LD network 130 (e.g., by tandem switch 115A) is first routed via one or more LD switches (e.g., LD switch 605A) to one of the USAN servers (e.g., USAN 610A). Using the shared database 625, the USAN server 610A determines the location of the destination telephone number and routes the call out of the LD network 130 via one or more LD switches (e.g., LD switch 605C) to a tandem switch (e.g., 115B). Alternatively, a call may be routed from a LD switch (e.g., LD switch 605B) directly to a customer (e.g., toll-free customer 140B) using a dedicated termination. Further, a call (e.g., a toll-free call) may be routed from the LD network 130 to a VoIP endpoint (e.g., a toll-free customer termination 140C located in a foreign country) via a gateway 615 and the IP based network 145.

The USAN servers 610A and 610B in the example of FIG. 6 also host an IVR based routing system. In particular, a caller to a toll-free telephone number may be provided with an IVR interface that allows them to provide additional destination information. For example, a caller may be prompted to select one item from a list of items (e.g., customer service, billing questions, technical support, etc.) by, for example, pressing or selecting keys on a telephone keypad of the phone used to initiate the toll-free call. Alternatively, the caller may speak responses. Based upon the caller's response, or lack thereof and the customized routing plan for the toll-free number configured by the customer, the USAN server 610A or 610B routes the call to the appropriate destination (e.g., a VoIP endpoint).

To allow exchange of data between the LD network 130 and the IP based network 145 (e.g., toll-free customer 140C), the LD network 130 of FIG. 6 includes a gateway 615. Using any of a variety of suitable techniques, the gateway 315 of FIG. 1 translates data associated with a toll-free call within the example LD network 130 from the time-division multiplexed (TDM) format used by the example circuit based LD network 130 to and from VoIP packets suitable for transmission across the IP based network 145 to a toll-free customer (e.g., toll-free customer 140C). In particular, the gateway 315 creates VoIP data packets from the Digital Signal Level 0 (DS0) used to transport the toll-free call within the LD network 130 and addresses the VoIP packets based upon, for example, the destination URL associated with the toll-free number. Likewise, the gateway 315 extracts data from VoIP packets received from the destination and places the data into the DS0 used to transport the toll-free call within the LD network 130. The process of converting calls from the LD network 130 to a VoIP network or endpoint is known to persons of ordinary skill in the art and, thus, is not described in further detail.

In the illustrated example of FIG. 6, the gateway 615 is implemented by, connected to, or associated with a USAN server (e.g., USAN 610A). For example, a toll-free call destined for a VoIP endpoint is routed from the USAN server 610A directly via the gateway 615 to the IP based network 145. It will be readily apparent to persons of ordinary skill in the art that the LD network 130 may include a plurality of gateways. For example, a gateway could be implemented by, connected to, or associated with each of the USAN servers 610A and 610B; a plurality of gateways could be implemented by, connected to, or associated with each of the USAN servers 610A and 610B; one or more gateways could be implemented separately from the USAN servers 610A and 610B and/or associated with more than one USAN server, etc. As an example standalone device, the gateway 615 may be implemented using any suitable PC, computer server, network server, etc.

To allow the toll-free customer via the interface device 150 to customize toll-free routing plans, the example LD network 130 of FIG. 6 includes a configuration server 620 implemented, for example, within a USAN server (e.g., the USAN server 610A). The configuration server 620 of the illustrated example of FIG. 6 provides, for example, web based user interfaces to the interface device 150 via the IP based network 145 as described above. The configuration server 620 also interacts, for example, with other portions of the USAN server 610A to create, update and manage toll-free routing configurations. Alternatively, the configuration server 620 implements an IVR system as described above.

In the illustrated example of FIG. 6, the configuration server 620 is implemented by, within, connected to, or associated with a USAN server (e.g., USAN 610A). It will be readily apparent to persons of ordinary skill in the art that the LD network 130 may include one or more configuration servers. For example, a configuration server could be implemented by, connected to, or associated with each of the USAN servers 610A and 610B; a plurality of configuration servers could be implemented by, connected to, or associated with each of the USAN servers 610A and 610B; one or more configuration servers could be implemented separately from the USAN servers 610A and 610B and/or associated with more than one USAN server, etc. As an example standalone device, the configuration server 620 may be implemented using any suitable PC, computer server, network server, etc.

While the methods and apparatus discussed herein are described with reference to the example circuit-based LD network 130 of FIG. 1, the example manner of implementing the example call router 137 illustrated in FIG. 3, and the example manner of implementing the example circuit-based LD network 130 illustrated in FIG. 6, it will be understood by persons of ordinary skill in the art that other network technologies or architectures could be used to implement the LD network 130 of FIGS. 1 and 6 and the example call router 137 illustrated in FIG. 3. For example, a wireless network, a VoIP network, a public switched network, an Internet based network, a frame relay based network, an asynchronous transfer mode (ATM) based network, etc.

FIG. 7 is a schematic diagram of an example processor platform 700 capable of executing the example machine readable instructions of FIG. 4, the example call router 137 and/or the example LD network 130. For example, the processor platform 700 can be implemented by one or more general purpose microprocessors, microcontrollers, etc.

In a networked deployment, the example processor platform 700 may operate in the capacity of a server or as a client user computer in a server-client user network environment, or as a peer computer system in a peer-to-peer (or distributed) network environment. The example processor platform 700 can also be implemented as or incorporated into various devices, such as a personal computer (PC), a tablet PC, a set-top box (STB), a personal digital assistant (PDA), a mobile device, a palmtop computer, a laptop computer, a desktop computer, a communications device, a wireless telephone, a land-line telephone, a control system, a camera, a scanner, a facsimile machine, a printer, a pager, a personal trusted device, a web appliance, a network router, switch or bridge, and/or any other machine capable of executing a set of instructions (sequential or otherwise) that specify actions to be taken by that machine. Further, the example processor platform 700 can be implemented using one or more electronic devices that provide voice, video or data communication. While a single example processor platform 700 is illustrated, the term “system” shall also be taken in this patent to include any collection of systems or sub-systems that individually or jointly execute a set, or multiple sets, of instructions to perform one or more functions.

The processor platform 700 of the example of FIG. 7 includes a general purpose programmable processor 710. The processor 710 executes coded instructions 727 present in main memory of the processor 710 (e.g., within a RAM 725). The processor 710 may be any type of processing unit, such as a microprocessor from the Intel®, AMD®, IBM®, or SUN® families of microprocessors. The processor 710 may implement, among other things, the example machine readable instructions of FIG. 4, the example call router 137 and/or the example LD network 130.

The processor 710 is in communication with the main memory (including a read only memory (ROM) 720 and the RAM 725) via a bus 705. The RAM 725 may be implemented by Synchronous Dynamic Random Access Memory (SDRAM), Dynamic DRAM, and/or any other type of RAM device. The ROM 720 may be implemented by flash memory and/or any other desired type of memory device. Access to the memory 720 and 725 is typically controlled by a memory controller (not shown) in a conventional manner.

The processor platform 700 also includes a conventional interface circuit 730. The interface circuit 730 may be implemented by any type of well known interface standard, such as an external memory interface, serial port, general purpose input/output, etc.

One or more input devices 735 and one or more output devices 740 are connected to the interface circuit 730. The input devices 735 and output devices 740 may be used to implement interfaces between, for example, the example LD network 130 and the IP based network 145, the LD network 130 and a tandem switch, interfaces within and between elements implementing the LD network 130, etc.

Of course, persons of ordinary skill in the art will recognize that the order, size, and proportions of the memory illustrated in the example systems may vary. Additionally, although this patent discloses example systems including, among other components, software or firmware executed on hardware, it should be noted that such systems are merely illustrative and should not be considered as limiting. For example, it is contemplated that any or all of these hardware and software components could be embodied exclusively in hardware, exclusively in software, exclusively in firmware or in some combination of hardware, firmware and/or software. Accordingly, persons of ordinary skill in the art will readily appreciate that the above described examples are not the only way to implement such systems.

At least some of the above described example methods and/or apparatus are implemented by one or more software and/or firmware programs running on a computer processor. However, dedicated hardware implementations including, but not limited to, an ASIC, programmable logic arrays and other hardware devices can likewise be constructed to implement some or all of the example methods and/or apparatus described herein, either in whole or in part. Furthermore, alternative software implementations including, but not limited to, distributed processing or component/object distributed processing, parallel processing, or virtual machine processing can also be constructed to implement the example methods and/or apparatus described herein.

It should also be noted that the example software and/or firmware implementations described herein are optionally stored on a tangible storage medium, such as: a magnetic medium (e.g., a disk or tape); a magneto-optical or optical medium such as a disk; or a solid state medium such as a memory card or other package that houses one or more read-only (non-volatile) memories, random access memories, or other re-writable (volatile) memories; or a signal containing computer instructions. A digital file attachment to e-mail or other self-contained information archive or set of archives is considered a distribution medium equivalent to a tangible storage medium. Accordingly, the example software and/or firmware described herein can be stored on a tangible storage medium or distribution medium such as those described above or equivalents and successor media.

Although the present specification describes example components and example functions that may be implemented with reference to particular standards and protocols, no claim of this patent is limited to such standards and protocols unless explicitly so stated in the claim itself. For example, standards for Internet and other packet switched network transmission (e.g., VoIP, Transmission Control Protocol (TCP)/IP, User Datagram Protocol (UDP)/IP, HTML, HyperText Transfer Protocol (HTTP)) represent examples of the state of the art. Such standards are periodically superseded by different, faster and/or more efficient equivalents. Accordingly, replacement standards and protocols to those disclosed herein are considered equivalents thereof.

The above disclosed subject matter is to be considered illustrative, and not restrictive, and the appended claims are intended to cover any and all modifications, enhancements, and other examples which fall within the true spirit and scope of this patent. Thus, to the maximum extent allowed by law, the scope of the claims are to be determined by the broadest permissible interpretation, and shall not be restricted or limited by the foregoing detailed description.

Although certain example methods, apparatus and articles of manufacture have been described herein, the scope of coverage of this patent is not limited thereto. On the contrary, this patent covers all methods, apparatus and articles of manufacture fairly falling within the scope of the appended claims either literally or under the doctrine of equivalents.

What is claimed is:

1. A system comprising:
a telephone network to route a telephone call placed to a toll-free telephone number to a Voice over Internet Protocol (VoIP) endpoint.

2. A system as defined in claim 1, wherein the VoIP endpoint is a VoIP telephone device or a VoIP server.

3. A system as defined in claim 1, wherein the VoIP endpoint supports a session initiated protocol (SIP).

4. A system as defined in claim 1, wherein a route through the telephone network is chosen based upon at least one of a universal resource locator (URL) or an Internet Protocol (IP) address associated with the VoIP endpoint.

5. A system as defined in claim 1, further comprising a gateway to connect the telephone network with the VoIP endpoint via an Internet Protocol (IP) based network.

6. A system as defined in claim 1, wherein the telephone network is to route the telephone call placed to the toll-free telephone number to one of the VoIP endpoint, a Plain Old Telephone Service (POTS) endpoint or a dedicated trunk endpoint based on a state of a least one variable.

7. A system as defined in claim 6, wherein the at least one variable comprises at least one of a time-of-the-day variable, a day-of-the-week variable, a day-of-the-year variable, or a geographic location of a person placing the telephone call.

8. A system as defined in claim 1, further comprising a gateway to connect the telephone network with the VoIP endpoint via an Internet Protocol (IP) based network, wherein the telephone network is to route the telephone call placed to the toll-free telephone number to one of the VoIP endpoint, a Plain Old Telephone Service (POTS) endpoint or a dedicated trunk endpoint based on a state of a least one variable, and wherein a route through the telephone network and the IP based network is chosen based upon at least one of a universal resource locator (URL) or an Internet Protocol (IP) address associated with the VoIP endpoint.

9. A method comprising:
determining a telephone call placed to a toll-free telephone number is associated with a Voice over Internet Protocol (VoIP) endpoint; and
routing the call to the VoIP endpoint.

10. A method as defined in claim 9, wherein routing the call to the VoIP termination comprises routing the call through a gateway.

11. A method as defined in claim 9, wherein the destination for the VoIP endpoint is represented as at least one of a universal resource locator (URL) or Internet Protocol (IP) address.

12. A method as defined in claim 9, wherein the determining a telephone call placed to a toll-free telephone number is associated with the VoIP endpoint depends on a state of at least one of a time-of-the-day variable, a day-of-the-week variable, or a day-of-the-year variable.

13. A method as defined in claim 12, wherein the state of at least one of the time-of-the-day variable, the day-of-the-year variable or the day-of-the-week variable is determined by a customer associated with the toll-free telephone number.

14. An apparatus comprising:
a database to store a configuration record for a toll-free number; and
a call router to determine a Voice over Internet Protocol (VoIP) endpoint for the toll-free number based on the configuration record or select an endpoint based upon a user customizable day-of-the-year variable.

15. An apparatus as defined in claim 14, further comprising
a configuration server responsive to a customer associated with the toll-free number to customize the configuration record.

16. A method comprising:
subscribing to a toll-free telephone service;
configuring the toll-free telephone service to route a telephone call placed to the toll-free telephone service to a Voice over Internet Protocol (VoIP) endpoint; and
configuring the VoIP endpoint to receive the telephone call placed to the toll-free telephone service.

17. A method as defined in claim 16, wherein the VoIP endpoint is a VoIP telephone device or a VoIP server.

18. A method as defined in claim 16, wherein configuring the toll-free telephone service comprising configuring the toll-free telephone service with at least one of a universal resource locator (URL) or an Internet Protocol (IP) address associated with the VoIP endpoint.

19. A method as defined in claim 16, wherein the VoIP endpoint is a VoIP server; and wherein configuring the VoIP endpoint comprises configuring the VoIP server to route the telephone call to a VoIP device communicatively coupled to the VoIP server.

20. A system comprising:
a configuration record associated with a toll-free telephone number comprising at least one of a user customizable day-of-the-year variable; and
a telephone network to route telephone calls placed to the toll-free telephone number based on the customizable configuration record.

21. A system as defined in claim 20, wherein the configuration record defines at least one holiday.

22. A system as defined in claim 20, wherein the configuration record defines at least one destination for calls placed to the toll-free telephone number for each of a plurality of days of the year contained in the configuration record.

23. A system as defined in claim 20, wherein the configuration record further comprises at least one customizable day-of-the-week variable or at least one customizable time-of-the-day variable.

24. A system as defined in claim 20, wherein the customization is performed by the customer via an Internet based interface.

25. A method comprising:
determining a destination for a call placed to a toll-free telephone based upon at least one customizable day-of-the-year variable; and
routing the call to the destination.

26. A method as defined in claim 25, wherein the at least one customizable day-of-the-year variable define at least one holiday.

27. A method as defined in claim 25, wherein the at least one customizable day-of-the-year variable includes at least one destination for each of a plurality of days of the year.

28. An article of manufacture storing machine readable instructions which, when executed, cause a machine to route a toll-free telephone call to a destination based upon at least one customizable day-of-the-year variable.

29. An article of manufacture as defined in claim 28, wherein the machine readable instructions, when executed, cause the machine to set the at least one customizable day-of-the-year variable in response to at least one customer input.

30. An article of manufacture as defined in claim 28, wherein the at least one customer input is provided using a web based interface.
